(19) United States
(12) Patent Application Publication
(10) Pub. No.: US 2025/0271695 A1
(43) Pub. Date: Aug. 28, 2025

(54) COLOR FILTER SUBSTRATE AND DISPLAY DEVICE

(71) Applicant: HANNSTAR DISPLAY CORPORATION, Taipei City (TW)

(72) Inventors: Wei-Chi Wu, Taipei City (TW); Yao-Chih Chuang, Taipei City (TW); Chih-Wei Chen, Taipei City (TW); Wai-Chen Lin, Taipei City (TW); Yung-Tsung Chen, Taipei City (TW); Kuo-Feng Chen, Taipei City (TW)

(73) Assignee: HANNSTAR DISPLAY CORPORATION, Taipei City (TW)

(21) Appl. No.: 18/946,952

(22) Filed: Nov. 14, 2024

Related U.S. Application Data
(60) Provisional application No. 63/556,404, filed on Feb. 22, 2024.

(30) Foreign Application Priority Data
Apr. 12, 2024 (TW) 113113660

(51) Int. Cl. G02F 1/1335

(52) U.S. Cl. CPC G02F 1/133514

(57) ABSTRACT

This invention discloses a color filter substrate and a display device. The color filter substrate includes a substrate, a first color resist, a second color resist, and a third color resist. The substrate has a pixel region which includes a first sub-pixel region, a second sub-pixel region, and a third sub-pixel region, and each of the first sub-pixel region and the second sub-pixel region includes a first portion and a second portion. The first color resist is disposed in the first portion of the first sub-pixel region. The second color resist is disposed in the first portion of the second sub-pixel region. The third color resist is disposed in the first sub-pixel region, the second sub-pixel region, and the third sub-pixel region. The first color resist, the second color resist, and the third color resist have different colors, and the color of the third color resist is blue.

### CROSS REFERENCE TO RELATED APPLICATIONS

This application claims the benefit of U.S. Provisional Application No. 63/556,404, filed on Feb. 22, 2024. The content of the application is incorporated herein by reference.

### BACKGROUND OF THE INVENTION

### 1. Field of the Invention

The present invention relates to a color filter substrate and a display device, and more particularly, to a color filter substrate and a display device with an overlapping structure of color resists.

### 2. Description of the Prior Art

Display devices possess the advantages of thinness and low power consumption and have been widely used in various electronic products, such as Desktop PCs, Notebook PCs, Tablet PCs, smartphones, etc. In the display device, the color of the light emitted by the light source may change after the light has passed some layers, and the color of the light may be changed due to the materials of these layers. The change in the color of the light makes the preset white point of the display shift (such as the yellow shift), thus affecting the display quality of the display device.

### SUMMARY OF THE INVENTION

This invention aims to provide a color filter substrate and a display device for solving the technical problem of improving the color accuracy of images displayed by the display device to improve the display quality.

In order to solve the above technical problems, the present invention provides a color filter substrate including a substrate, a first color resist, a second color resist, and a third color resist. The substrate has a pixel region including a first sub-pixel region, a second sub-pixel region, and a third sub-pixel region, and each of the first sub-pixel region and the second sub-pixel region includes a first portion and a second portion. The first color resist is disposed on the substrate and in the first portion of the first sub-pixel region. The second color resist is disposed on the substrate and in the first portion of the second sub-pixel region. The third color resist is disposed on the substrate and in the first portion and the second portion of the first sub-pixel region, the first portion and the second portion of the second sub-pixel region, and the third sub-pixel region. The first color resist, the second color resist, and the third color resist have different colors, and the color of the third color resist is blue.

In order to solve the above technical problems, the present invention provides a display device including the above-mentioned color filter substrate and an array substrate, and the array substrate and the color filter substrate are disposed opposite to each other.

In the color filter substrate and the display device of the present invention, the structure in which the third color resist covers the first color resist and the second color resist can be used to adjust the b* value of light to alleviate the yellow shift of the white point. Additionally, by reducing the areas of the first color resist and the second color resist, higher brightness can be obtained and the yellow shift of the white point can be alleviated as well, thereby improving the display quality of the display device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a cross-sectional view of the display device according to an embodiment of the present invention.

FIG. 2 is a schematic diagram illustrating a top view of a pixel region according to an embodiment of the present invention.

FIG. 3 is a schematic diagram illustrating a cross-sectional view of a substrate and a color resist layer along a line A-A′ in FIG. 2.

FIG. 4 is a schematic diagram illustrating a cross-sectional view of the substrate and the color resist layer along a line B-B′ in FIG. 2.

FIG. 5 is a diagram illustrating the relationship between color coordinate values and different thicknesses of a transparent conductive layer according to an embodiment of the present invention.

FIG. 6 is a schematic diagram illustrating forming a first color resist in a manufacturing method of a color filter substrate according to an embodiment of the present invention.

FIG. 7 is a schematic diagram illustrating forming a second color resist in a manufacturing method of a color filter substrate according to an embodiment of the present invention.

### DETAILED DESCRIPTION

To provide a better understanding of the present invention to those skilled in this field, preferred embodiments will be detailed as follows. The preferred embodiments of the present invention are illustrated in the accompanying drawings to elaborate on the contents and effects to be achieved. It should be noted that the drawings are simplified schematics, and therefore show only the components and combinations associated with the present invention, to provide a clearer description of the basic architecture or method of implementation. The components would be complex in reality. In addition, for ease of explanation, the components shown in the drawings may not represent their actual number, shape, and dimensions; details can be adjusted according to design requirements.

A direction DR1, a direction DR2, and a direction DR3 are shown in the following drawings. The direction DR3 may be the normal direction or the top view direction. The direction DR1 and the direction DR2 may be horizontal directions and perpendicular to the direction DR3. The direction DR1 and the direction DR2 are different, for example, the direction DR1 may be perpendicular to the direction DR2. The spatial relationship of the structure can be described according to the directions DR1, DR2, and DR3 in the following drawings.

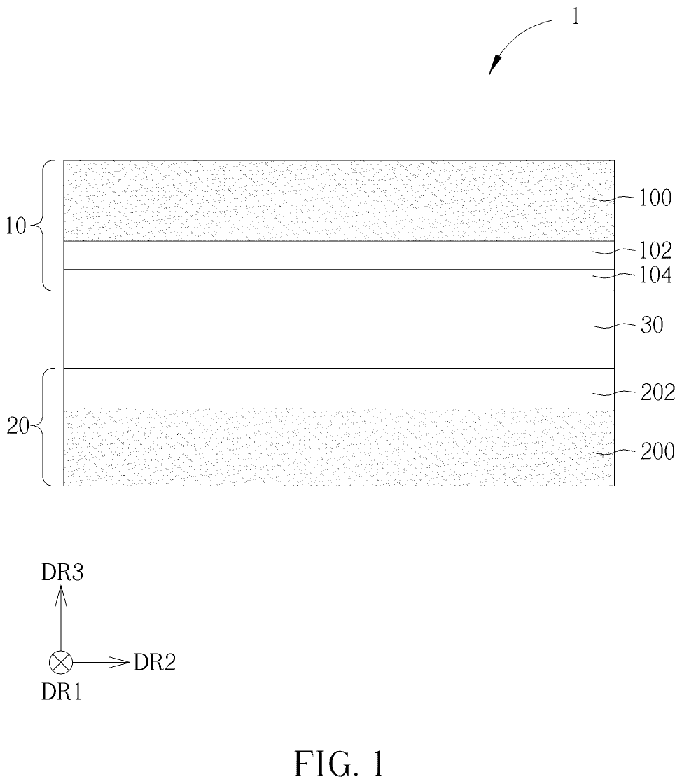

Referring to FIG. 1, it is a schematic diagram illustrating a cross-sectional view of the display device according to an embodiment of the present invention. A display device 1 includes a color filter substrate 10 and an array substrate 20, and the array substrate 20 and the color filter substrate 10 are disposed opposite to each other. In addition, the display device 1 may include a display medium layer 30 which can be disposed between the color filter substrate 10 and the array substrate 20, and the display medium layer 30 may include, but is not limited to, liquid crystal.

The color filter substrate 10 includes a substrate 100, a color resist layer 102, and a transparent conductive layer 104, but not limited thereto. The color resist layer 102 and the transparent conductive layer 104 can be disposed on the substrate 100, and the color resist layer 102 can be disposed between the transparent conductive layer 104 and the substrate 100, but not limited thereto. The transparent conductive layer 104 may include indium tin oxide (ITO), but not limited thereto. The transparent conductive layer 104 can be used as a common electrode, but not limited thereto.

In some embodiments, the color filter substrate 10 may further include a black matrix layer (BM layer), and the black matrix layer may be disposed on the substrate 100, but not limited thereto. In some embodiments, the color filter substrate 10 may further include a planarization layer, and the planarization layer may be disposed between the color resist layer 102 and the transparent conductive layer 104, but not limited thereto.

The array substrate 20 includes a substrate 200 and a circuit layer 202, but not limited thereto. The circuit layer 202 is disposed on the substrate 200 and may be disposed between the substrate 200 and the display medium layer 30. The circuit layer 202 may include scanning lines, data lines, thin film transistors, pixel electrodes, and other elements, but not limited thereto. The transparent conductive layer 104 can for example be used as a common electrode, and the transparent conductive layer 104 can collaborate with pixel electrodes (not shown) in the array substrate 20 for driving the display medium layer 30 to display corresponding images, but not limited thereto. For example, in the embodiment where the display device 1 is a liquid crystal display device, the display medium layer 30 can be a liquid crystal layer, and the electric field between the transparent conductive layer 104 and the pixel electrodes (not shown) can drive the liquid crystal molecules in the liquid crystal layer to display corresponding images. In other embodiments, the transparent conductive layer 104 may be disposed in the array substrate 20.

In the present invention, the substrate 100 and the substrate 200 may include rigid substrates or flexible substrates, but not limited thereto. The material of the rigid substrate may include glass, ceramics, quartz, or sapphire, but not limited thereto. The material of the flexible substrate may include polyimide (PI), polycarbonate (PC), polyethylene terephthalate (PET), or poly(methyl methacrylate) (PMMA), but not limited thereto.

In some embodiments, the display device 1 may be a transmissive display device. The display device 1 may further include a backlight module (not shown) disposed on the side of the array substrate 20 away from the display medium layer 30. The light of the backlight module can penetrate through the array substrate 20, the display medium layer 30, and the color filter substrate 10 to display corresponding images.

In other embodiments, the display device 1 may be a reflective display device or a transflective display device. In the embodiment where the display device 1 is the reflective display device, the array substrate 20 includes a plurality of sub-pixels (not shown), each of the sub-pixels has a reflective region, and a reflective plate is disposed in the reflective region and reflects the ambient light or the light from the front light module to form a reflected light to display images. In the embodiment where the display device 1 is the transflective display device, the display device 1 may further include a backlight module (not shown) disposed on the side of the array substrate 20 away from the display medium layer 30. The array substrate 20 includes a plurality of sub-pixels (not shown), and each of the sub-pixels has a reflective region and a transmissive region. The reflective plate is disposed in the reflective region and reflects the ambient light or the light from the front light module to form the reflected light to display images. The transmissive region does not have the reflective plate, and the light from the backlight module can pass through the transmissive region to form a penetrating light to display images when the backlight module is turned on.

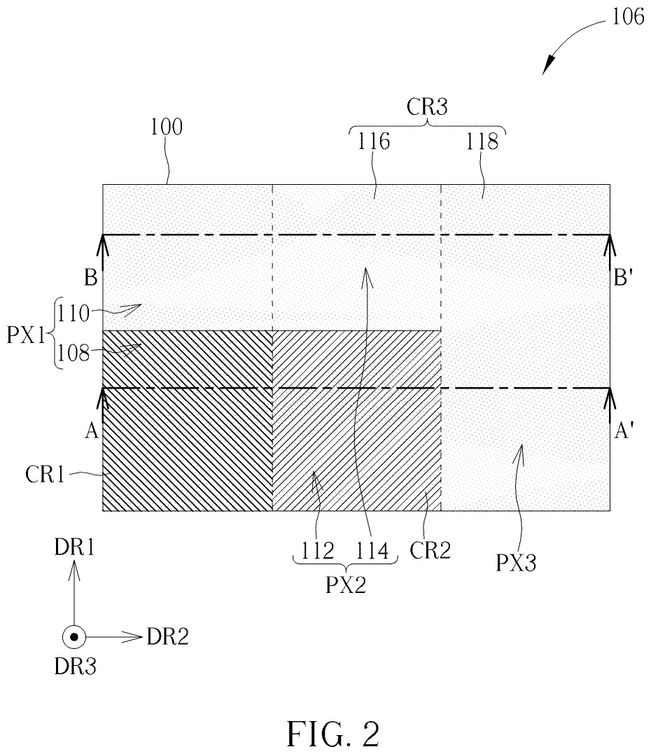

Referring to FIG. 2, it is a schematic diagram illustrating a top view of a pixel region according to an embodiment of the present invention. The substrate 100 in the color filter substrate 10 has a pixel region 106, and the pixel region 106 includes a first sub-pixel region PX1, a second sub-pixel region PX2, and a third sub-pixel region PX3. The first sub-pixel region PX1, the second sub-pixel region PX2, and the third sub-pixel region PX3 may be disposed along the direction DR2, and the second sub-pixel region PX2 may be disposed between the first sub-pixel region PX1 and the third sub-pixel region PX3, but not limited thereto. In some embodiments, the first sub-pixel region PX1, the second sub-pixel region PX2, and the third sub-pixel region PX3 in the pixel region 106 may not be arranged in a straight line. It should be noted that FIG. 2 only shows a top view of one of the pixel regions 106 of the color filter substrate 10. The substrate 100 in the color filter substrate 10 can have a plurality of pixel regions 106, and these pixel regions 106 can be arranged in an array.

Each of the first sub-pixel region PX1 and the second sub-pixel region PX2 includes a first portion and a second portion. As shown in FIG. 2, the first sub-pixel region PX1 includes a first portion 108 and a second portion 110, and the second sub-pixel region PX2 includes a first portion 112 and a second portion 114. The first portion 108 and the second portion 110 of the first sub-pixel region PX1 are adjacent to each other in the direction DR1, and the first portion 112 and the second portion 114 of the second sub-pixel region PX2 are adjacent to each other in the direction DR1, but not limited thereto. In the direction DR2, the first portion 108 of the first sub-pixel region PX1 and the first portion 112 of the second sub-pixel region PX2 may be disposed adjacent to each other, and the second portion 110 of the first sub-pixel region PX1 and the second portion 114 of the second sub-pixel region PX2 may be disposed adjacent to each other, but not limited thereto.

The color resist layer 102 of the color filter substrate 10 in FIG. 1 can include a first color resist CR1, a second color resist CR2, and a third color resist CR3 in FIG. 2, and the first color resist CR1, the second color resist CR2, and the third color resist CR3 are disposed on the substrate 100 of the color filter substrate 10. In addition, the transparent conductive layer 104 is disposed on the first color resist CR1, the second color resist CR2, and the third color resist CR3, and the first color resist CR1, the second color resist CR2, and the third color resist CR3 are disposed between the transparent conductive layer 104 and the substrate 100.

The first color resist CR1 is disposed in the first portion 108 of the first sub-pixel region PX1, and the second color resist CR2 is disposed in the first portion 112 of the second sub-pixel region PX2. Since the first color resist CR1 is not disposed in the second portion 110 of the first sub-pixel region PX1 and the second color resist CR2 is not disposed in the second portion 114 of the second sub-pixel region PX2, the first color resist CR1 does not fill all the first sub-pixel region PX1 and the second color resist CR2 does not fill all the second sub-pixel region PX2.

The third color resist CR3 is disposed in the first portion 108 and the second portion 110 of the first sub-pixel region PX1, the first portion 112 and the second portion 114 of the second sub-pixel region PX2, and the third sub-pixel region PX3. A portion 116 of the third color resist CR3 (indicated by dots in FIG. 2) can be disposed in the first sub-pixel region PX1 and the second sub-pixel region PX2, and another portion 118 of the third color resist CR3 may be disposed in the third sub-pixel region PX3. Specifically, the third color resist CR3 is disposed in all the areas of the first sub-pixel region PX1, the second sub-pixel region PX2, and the third sub-pixel region PX3.

The first color resist CR1, the second color resist CR2, and the third color resist CR3 have different colors. The color of one of the first color resist CR1 and the second color resist CR2 and the color of the other one of the first color resist CR1 and the second color resist CR2 can respectively be green and red (i.e., the color of the first color resist CR1 and the color of the second color resist CR2 are respectively green and red, or the color of the first color resist CR1 and the color of the second color resist CR2 are respectively red and green), and the color of the third color resist CR3 is blue. For example, in this embodiment, the color of the first color resist CR1 is green, the color of the second color resist CR2 is red, and the color of the third color resist CR3 is blue, but not limited thereto.

In some embodiments, a ratio of an area of the first portion 108 of the first sub-pixel region PX1 to an area of the first sub-pixel region PX1 is greater than or equal to 0.4 and less than or equal to 0.8, or a ratio of an area of the first portion 112 of the second sub-pixel region PX2 to an area of the second sub-pixel region PX2 is greater than or equal to 0.4 and less than or equal to 0.8. For example, as shown in FIG. 2, the ratio of the area of the first portion 108 of the first sub-pixel region PX1 to the area of the first sub-pixel region PX1 and the ratio of the area of the first portion 112 of the second sub-pixel region PX2 to the area of the second sub-pixel region PX2 are both greater than or equal to 0.4 and less than or equal to 0.8, but not limited thereto. Therefore, the area of the first color resist CR1 can be only 40% to 80% of the area of the first sub-pixel region PX1, and the area of the second color resist CR2 can be only 40% to 80% of the area of the second sub-pixel region PX2.

In some embodiments, the ratio of the area of the first portion 108 of the first sub-pixel region PX1 to the area of the first sub-pixel region PX1 is 0.6, or the ratio of the area of the first portion 112 of the second sub-pixel region PX2 to the area of the second sub-pixel region PX2 is 0.6. For example, as shown in FIG. 2, the ratio of the area of the first portion 108 of the first sub-pixel region PX1 to the area of the first sub-pixel region PX1 and the ratio of the area of the first portion 112 of the second sub-pixel region PX2 to the area of the second sub-pixel region PX2 are both 0.6, but not limited thereto. Therefore, the area of the first color resist CR1 can be only 60% of the area of the first sub-pixel region PX1, and the area of the second color resist CR2 can be only 60% of the area of the second sub-pixel region PX2.

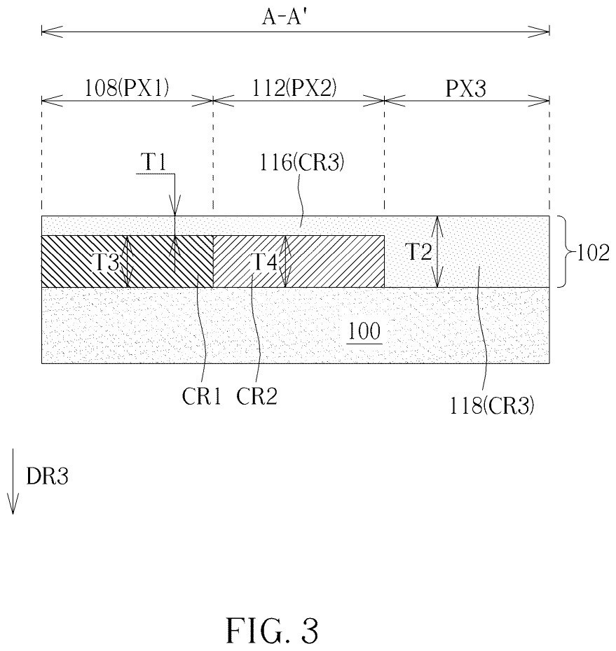

Referring to FIG. 3, it is a schematic diagram illustrating a cross-sectional view of a substrate and a color resist layer along a line A-A′ in FIG. 2. The third color resist CR3 covers the first color resist CR1 in the first portion 108 of the first sub-pixel region PX1, and the third color resist CR3 covers the second color resist CR2 in the first portion 112 of the second sub-pixel region PX2. Specifically, the portion 116 of the third color resist CR3 is disposed on the first color resist CR1 and the second color resist CR2, and the first color resist CR1 and the second color resist CR2 are disposed between the portion 116 of the third color resist CR3 and the substrate 100. In the direction DR3, the portion 116 of the third color resist CR3 overlaps the first color resist CR1 and the second color resist CR2. The portion 116 of the third color resist CR3 may be in direct contact with the first color resist CR1, and the portion 116 of the third color resist CR3 may also be in direct contact with the second color resist CR2, but not limited thereto.

The portion 116 of the third color resist CR3 disposed in the first portion 108 of the first sub-pixel region PX1 or the first portion 112 of the second sub-pixel region PX2 has a first thickness T1, and the portion 118 of the third color resist CR3 disposed in the third sub-pixel region PX3 has a second thickness T2, and the first thickness T1 is less than the second thickness T2. In addition, the first thickness T1 of the portion 116 of the third color resist CR3 is less than a thickness T3 of the first color resist CR1 or a thickness T4 of the second color resist CR2, and the second thickness T2 of the portion 118 of the third color resist CR3 is greater than the thickness T3 of the first color resist CR1 or the thickness T4 of the second color resist CR2.

For example, the first thickness T1 of the portion 116 of the third color resist CR3 is less than the thickness T3 of the first color resist CR1, the first thickness T1 of the portion 116 of the third color resist CR3 is less than the thickness T4 of the second color resist CR2, the second thickness T2 of the portion 118 of the third color resist CR3 is greater than the thickness T3 of the first color resist CR1, and the second thickness T2 of the portion 118 of the third color resist CR3 is greater than the thickness T4 of the second color resist CR2. In this disclosure, the thickness can be measured along the direction DR3. In the present invention, the third color resist CR3 can completely cover the first color resist CR1 in the first sub-pixel region PX1 and the second color resist CR2 in the sub-pixel region PX2.

At least one of the thickness T3 of the first color resist CR1 and the thickness T4 of the second color resist CR2 can be greater than or equal to 0.5 micrometers and less than or equal to 3 micrometers. The first thickness T1 of the portion 116 of the third color resist CR3 can be greater than or equal to 0.2 micrometers and less than or equal to 0.5 micrometers, and the second thickness T2 of the portion 118 of the third color resist CR3 can be greater than or equal to 0.7 micrometers and less than or equal to 3.5 micrometers, but not limited thereto.

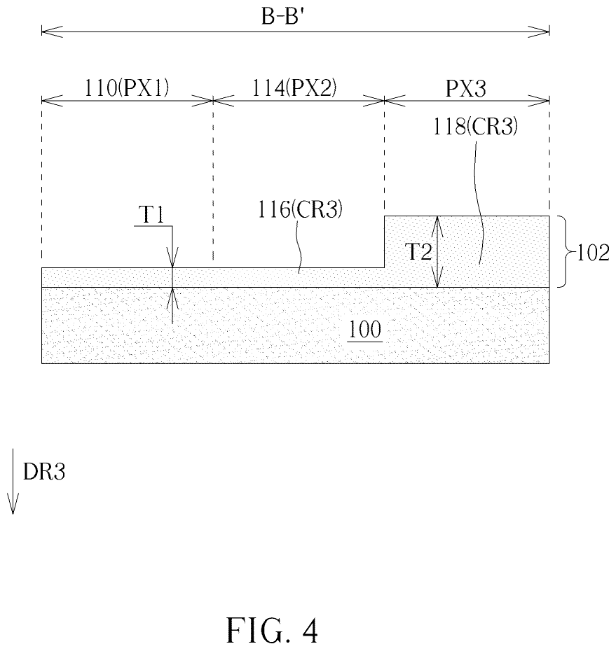

Referring to FIG. 4, it is a schematic diagram illustrating a cross-sectional view of the substrate and the color resist layer along a line B-B′ in FIG. 2. The thickness of the portion 116 of the third color resist CR3 disposed in the second portion 110 of the first sub-pixel region PX1 and the second portion 114 of the second sub-pixel region PX2 is less than the thickness of the portion 118 of the third color resist CR3 disposed in the third sub-pixel region PX3. The portion 116 of the third color resist CR3 disposed in the second portion 110 of the first sub-pixel region PX1 or the second portion 114 of the second sub-pixel region PX2 has the first thickness T1, but not limited thereto. For example, the portion 116 of the third color resist CR3 disposed in both the second portion 110 of the first sub-pixel region PX1 and the second portion 114 of the second sub-pixel region PX2 has the first thickness T1, but not limited thereto. The portion 118 of the third color resist CR3 disposed in the third sub-pixel region PX3 has the second thickness T2, and the first thickness T1 is less than the second thickness T2. In the second portion 110 of the first sub-pixel region PX1, the second portion 114 of the second sub-pixel region PX2, and the third sub-pixel region PX3, the third color resist CR3 may be in direct contact with the substrate 100, but not limited thereto.

The first color resist CR1, the second color resist CR2, and the third color resist CR3 may include polymer materials, but not limited thereto. For example, the color of the first color resist CR1 can be green. When the thickness of the first color resist CR1 is 1 micrometer, the absorption rate of the first color resist CR1 for light in the wavelength below 460 nanometers and the wavelength from 630 nanometers to 690 nanometers is greater than 0.4, the absorption rate for light in the wavelength from 640 nanometers to 680 nanometers is greater than 0.55, and the absorption rate for light in the wavelength from 490 nanometers to 580 nanometers is less than 0.1, but not limited thereto.

For example, the color of the second color resist CR2 can be red. When the thickness of the second color resist CR2 is 1 micrometer, the absorption rate of the second color resist CR2 for light in the wavelength from 430 nanometers to 570 nanometers is greater than 0.5, the absorption rate for light in the wavelength from 540 nanometers to 565 nanometers is greater than 0.7, and the absorption rate for light in the wavelength above 600 nanometers is less than 0.1, but not limited thereto.

For example, the color of the third color resist CR3 can be blue. When the thickness of the third color resist CR3 is 1 micrometer, the absorption rate of the third color resist CR3 for light in the wavelength from 530 nanometers to 770 nanometers is greater than 0.2, the absorption rate for light in the wavelength from 540 nanometers to 640 nanometers is greater than 0.35, and the absorption rate for light in the wavelength from 400 nanometers to 500 nanometers is less than 0.1, but not limited thereto.

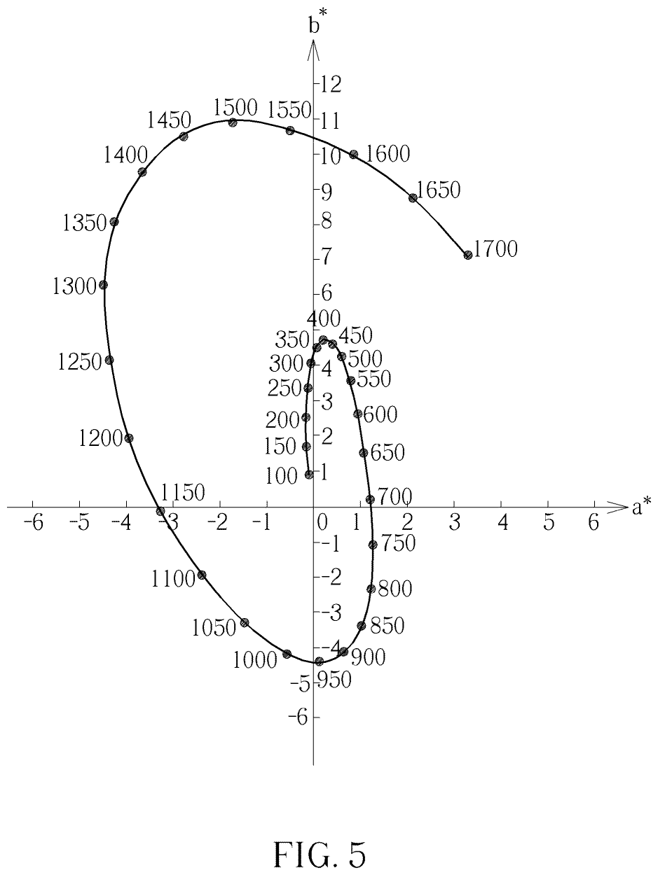

Referring to FIG. 5, it is a diagram illustrating the relationship between color coordinate values and different thicknesses of a transparent conductive layer according to an embodiment of the present invention. In FIG. 5, the horizontal axis corresponds to a* value and the vertical axis corresponds to b* value. When the light passes through the transparent conductive layer 104, the color of the light will change according to the thickness of the transparent conductive layer 104. To make the transparent conductive layer 104 have better conductivity, the thickness of the transparent conductive layer 104 may for example be greater than or equal to 1200 angstroms and less than or equal to 1700 angstroms, but not limited thereto. As shown in FIG. 5, the curve is the color coordinate values of the colors of light passing through the transparent conductive layers 104 with different thicknesses. According to FIG. 5, when the thickness of the transparent conductive layer 104 is 1200 angstroms to 1700 angstroms, the b* value is about 2 to 11, indicating that the color coordinate value corresponding to the light passing through the transparent conductive layer 104 is yellowish. Thus, the predetermined white point of the display is shifted (such as the yellow shift).

In the present invention, the structure in which the third color resist CR3 covers the first color resist CR1 and the second color resist CR2 can be used to adjust the b* value of light (e.g., reducing the b* value) to alleviate the yellow shift of the white point and further improve the display quality of the display device. However, the overlapping of color resist will reduce the optical transmittance and brightness. Therefore, by reducing the areas of the first color resist CR1 and the second color resist CR2, higher brightness can be obtained and the yellow shift of the white point can be alleviated as well. Compared with the structure in which the areas of the first color resist CR1 and the second color resist CR2 are not reduced and the first color resist CR1 and the second color resist CR2 are overlapped with the third color resist CR3, the b* value can be reduced by about 1 to 6 and the brightness can be increased by about 6% through the design of this invention.

Referring to FIG. 1 and FIG. 5, in the embodiment where the display device 1 is a transmissive display device, the light used for displaying an image will pass through the transparent conductive layer 104 once. In the embodiment where the display device 1 is a reflective display device or a transflective display device, the ambient light or the light from the front light module will pass through the transparent conductive layer 104 once, and the reflected light will also pass through the transparent conductive layer 104 once, thus the light used for displaying an image will pass through the transparent conductive layer 104 twice.

In the transmissive display device, the light used for displaying the image will pass through the transparent conductive layer of the color filter substrate once, causing the image to be yellowish (as shown in FIG. 5). In the reflective display device and the transflective display device, the light used for displaying the image will pass through the transparent conductive layer of the color filter substrate twice, causing the phenomenon of the yellowish image to be more severe than that of the transmissive display device. Therefore, the design of the first color resist CR1, the second color resist CR2, and the third color resist CR3 of the present invention can be applied not only to the transmissive display device but also to the reflective display device and the transflective display device, solving the more severe problem of the yellowish image.

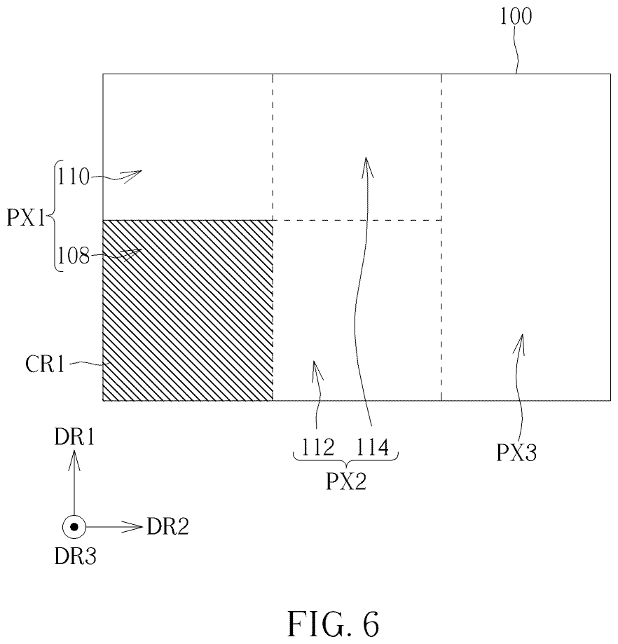

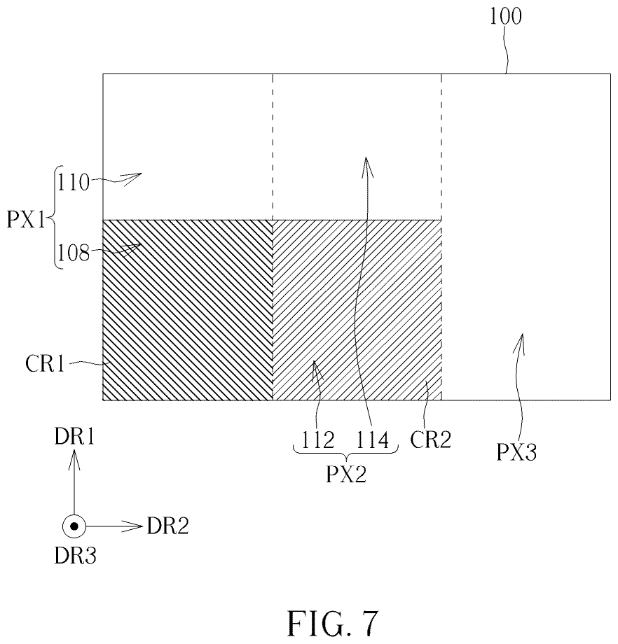

Referring to FIG. 6, FIG. 7, and FIG. 1, FIG. 6 is a schematic diagram illustrating forming a first color resist in a manufacturing method of a color filter substrate according to an embodiment of the present invention, and FIG. 7 is a schematic diagram illustrating forming a second color resist in a manufacturing method of a color filter substrate according to an embodiment of the present invention. Firstly, as shown in FIG. 6, the first color resist CR1 is coated in the first sub-pixel region PX1 of the substrate 100, and an expose process and a development process are performed in the first sub-pixel region PX1. After the aforementioned processes, the first color resist CR1 fills the first portion 108 of the first sub-pixel region PX1 and is not disposed in the second portion 110 of the first sub-pixel region PX1. The area of the first color resist CR1 may be 40% to 80% of the area of the first sub-pixel region PX1. For example, the area of the first color resist CR1 may be 60% of the area of the first sub-pixel region PX1.

Next, as shown in FIG. 7, the second color resist CR2 is coated in the second sub-pixel region PX2 of the substrate 100, and an expose process and a development process are performed in the second sub-pixel region PX2. After the aforementioned processes, the second color resist CR2 fills the first portion 112 of the second sub-pixel region PX2 and is not disposed in the second portion 114 of the second sub-pixel region PX2. The area of the second color resist CR2 may be 40% to 80% of the area of the second sub-pixel region PX2. For example, the area of the second color resist CR2 may be 60% of the area of the second sub-pixel region PX2. In some embodiments, the second color resist CR2 may be formed in the first portion 112 of the second sub-pixel region PX2 first, and the first color resist CR1 may be formed in the first portion 108 of the first sub-pixel region PX1 next.

After the first color resist CR1 and the second color resist CR2 are formed, the third color resist CR3 is coated in the first sub-pixel region PX1, the second sub-pixel region PX2, and third sub-pixel region PX3 of the substrate 100 as shown in FIG. 2, and an expose process and a development process are performed in 100% of the areas of the first, second, and third sub-pixel regions PX1, PX2, and PX3 (i.e., the whole pixel region 106). Therefore, the third color resist CR3 can be formed on the substrate 100 to cover the first color resist CR1 and the second color resist CR2.

It should be noted that in the above embodiment, the materials of the first color resist CR1, the second color resist CR2, and the third color resist CR3 may include negative photoresist materials (i.e., the illuminated part of the color resist material is insoluble in the developer) as an example, but not limited thereto. In some embodiments, the materials of the first color resist CR1, the second color resist CR1, and the third color resist CR3 may be positive photoresist materials, which will not further be described in detail. In addition, the method of forming the first color resist CR1, the second color resist CR2, and the third color resist CR3 of the present invention is not limited to the above embodiments.

In summary, in the color filter substrate and the display device of the present invention, the structure in which the third color resist covers the first color resist and the second color resist can be used to adjust the b* value of light to alleviate the yellow shift of the white point. Additionally, by reducing the areas of the first color resist and the second color resist, higher brightness can be obtained and the yellow shift of the white point can be alleviated as well, thereby improving the display quality of the display device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A color filter substrate, comprising:
a substrate having a pixel region including a first sub-pixel region, a second sub-pixel region, and a third sub-pixel region, wherein each of the first sub-pixel region and the second sub-pixel region includes a first portion and a second portion;
a first color resist disposed on the substrate and in the first portion of the first sub-pixel region;
a second color resist disposed on the substrate and in the first portion of the second sub-pixel region; and
a third color resist disposed on the substrate and in the first portion and the second portion of the first sub-pixel region, the first portion and the second portion of the second sub-pixel region, and the third sub-pixel region,
wherein the first color resist, the second color resist, and the third color resist have different colors, and the color of the third color resist is blue.

2. The color filter substrate according to claim 1, wherein a ratio of an area of the first portion of the first sub-pixel region to an area of the first sub-pixel region or a ratio of an area of the first portion of the second sub-pixel region to an area of the second sub-pixel region is greater than or equal to 0.4 and less than or equal to 0.8.

3. The color filter substrate according to claim 2, wherein the ratio of the area of the first portion of the first sub-pixel region to the area of the first sub-pixel region or the ratio of the area of the first portion of the second sub-pixel region to the area of the second sub-pixel region is 0.6.

4. The color filter substrate according to claim 1, wherein the third color resist covers the first color resist in the first portion of the first sub-pixel region, and the third color resist covers the second color resist in the first portion of the second sub-pixel region.

5. The color filter substrate according to claim 4, wherein a portion of the third color resist disposed in the first portion of the first sub-pixel region or the first portion of the second sub-pixel region has a first thickness, another portion of the third color resist disposed in the third sub-pixel region has a second thickness, and the first thickness is less than the second thickness.

6. The color filter substrate according to claim 5, wherein the first thickness is greater than or equal to 0.2 micrometers and less than or equal to 0.5 micrometers.

7. The color filter substrate according to claim 4, wherein a portion of the third color resist disposed in the first portion of the first sub-pixel region or the first portion of the second sub-pixel region has a thickness, and the thickness of the portion of the third color resist is less than a thickness of the first color resist or a thickness of the second color resist.

8. The color filter substrate according to claim 4, wherein a portion of the third color resist disposed in the third sub-pixel region has a thickness, and the thickness of the portion of the third color resist is greater than a thickness of the first color resist or a thickness of the second color resist.

9. The color filter substrate according to claim 8, wherein the color of one of the first color resist and the second color resist is green, and the color of the other of the first color resist and the second color resist is red.

10. The color filter substrate according to claim 1, wherein a portion of the third color resist disposed in the second portion of the first sub-pixel region or the second portion of the second sub-pixel region has a first thickness, another portion of the third color resist disposed in the third sub-pixel region has a second thickness, and the first thickness is less than the second thickness.

11. The color filter substrate according to claim 1, further comprising a transparent conductive layer disposed on the first color resist, the second color resist, and the third color resist.

12. A display device, comprising:
the color filter substrate according to claim 1; and
an array substrate, wherein the array substrate and the color filter substrate are disposed opposite to each other.
